(19) United States
(12) Patent Application Publication
(10) Pub. No.: US 2023/0121789 A1
(43) Pub. Date: Apr. 20, 2023

(54) Sensor Having a Housing

(71) Applicant: TDK Electronics AG, München (DE)

(72) Inventor: Octavio Flores, Berlin (DE)

(21) Appl. No.: 17/905,613

(22) PCT Filed: Apr. 16, 2021
(86) PCT No.: PCT/EP2021/059961

§ 371 Date: Sep. 2, 2022

(30) Foreign Application Priority Data
Apr. 16, 2020 (DE) 10 2020 110 438.3

(51) Int. Cl. G01K 1/10; G01K 7/22

(52) U.S. Cl. CPC G01K 1/10; G01K 7/22

(57) ABSTRACT

In an embodiment a sensor includes a sensor element, a connecting element configured for electrical connection and a housing located on the sensor element, wherein the housing comprises a housing material with cured liquid silicone rubber (LSR) as a main component.

This patent application is a national phase filing under section 371 of PCT/EP2021/059961, filed Apr. 16, 2021, which claims the priority of German patent application 102020110438.3, filed Apr. 16, 2020, each of which is incorporated herein by reference in its entirety.

### TECHNICAL FIELD

The present invention relates to a sensor comprising a sensor element, a connecting element for electrical connection and a housing for the sensor element.

### BACKGROUND

State of the art sensors use housings consisting of metal, ceramic or thermoplastic materials combined with inner fillings consisting of hardening materials such as thermoplastics, ceramic or epoxy resins.

The additional inner fillings are required to adapt the shape of the housing to the shape of the sensor element and to allow close mechanical and thermal contact between the sensor element and the housing. Ceramic and metal housings are difficult to miniaturize because of their comparatively large wall thicknesses and the required additional filler materials.

Furthermore, hard potted housings usually provide good mechanical protection, but limits the mechanical and thermal contact between the sensor element and the medium to be measured.

The patent DE 69323126 T2 discloses another technique using shrink tubes as housings for sensor elements. The element has a silicone elastomer coating, and is covered by an outer thin tube, which is heat shrinkable.

However, such housings have several drawbacks as the dimension and shape of the shrink tube are hard to control and adhesion between shrink tubes and connected electrical wires is low.

A further prior art document discloses the use of flexible sensors, in which the sensor elements are applied on polyimide foils, for example. On the other hand, such sensors are hardly protected against mechanical impact.

### SUMMARY

Embodiments provide an improved housing for a sensor element, which can be easily applied.

The sensor comprises a sensor element, a connecting element for electrical connection and a housing applied onto the sensor element. Here the housing comprises a housing material with cured liquid silicone rubber (LSR) as a main component.

In an embodiment, the sensor element has a cylindrical shape. The sensor element may have a diameter of 2.4 mm.

The sensor may be a sensor for temperature measurements. The sensor element may have any geometrical shape. The connecting element is mechanically and electrically connected to the sensor element.

The housing covers the whole sensor element tightly. It consists of an elastic housing material. Beside the main component liquid silicone rubber (LSR), the housing material may also comprise several filler materials or additives.

LSR has advantageous properties as a housing material. Due to its high flowability and low viscosity it can be easily formed during application of the housing material on the outside of the sensor element. This enables miniaturization and free design variation of housings. Furthermore, the wall thickness may be minimized. A low wall thickness shortens the response time of the sensor.

The application of LSR on the sensor element is smoother than the application of thermoplastic materials used in state of the art sensors due to low injection pressures and no shrinkage behaviour during the process. Therefore LSR can be applied even to sensitive mechanical structures.

The low compression set, typically from 5 to 25%, and the high elongation before breaking of more than 100% of LSR housings allow a soft and smooth application. Therefore the outer surface of the LSR housing easily adapts to the surface to be measured and a good thermal contact can be reached.

Because of the high heat resistance of LSR the sensor is suitable for applications under harsh operating conditions and designed for temperature measurements in an extended measuring range from −40° C. up to 250° C.

As filler materials oxide ceramics may be used. The oxide ceramics may contain oxides of silicon or aluminium like silica, montmorillonite or Al₂O₃. Further, the filler materials may comprise nitrides such as AlN and BN. Besides these, carbides such as SiC may be used. By means of the filler materials the properties of the housing can be improved or modified. Examples of properties which can be modified by the filler materials are tensile strength, hardness, dielectric strength, thermal conductivity and thermal expansion of the housing material.

As LSR is the main component, the ratio of filler material in the housing material is below 50 wt %. The diameters of the particles of the filler material are preferably between 10 nm and 20 μm.

In an embodiment, the sensor element comprises a temperature-sensitive member.

The temperature-sensitive member may comprise a thermistor material for detecting a temperature.

Since the electric conductivity of thermistor materials depends on the temperature, such a material may be used in a temperature sensor. The thermistor material may have a negative temperature coefficient (NTC). In another embodiment the thermistor material may have a positive temperature coefficient (PTC).

In an embodiment, the sensor element comprises a lead connected to the temperature-sensitive member. The lead enables electrical connection of the sensor element.

In an embodiment, a pair of leads is connected to the temperature-sensitive member.

In an embodiment, the connecting element comprises an electrical wire.

In an embodiment the wire is a single wire. In another embodiment the wire is a multiple stranded wire. In a preferred embodiment two electrical wires are connected to the sensor element.

In an embodiment, the electrical wire is insulated with an insulation material, i.e. silicone. The wire may be a single wire or a multiple stranded wire.

In a preferred embodiment two electrical wires are connected to the leads of the sensor element. The connection between the electrical wires and the leads of the sensor element may be done by crimping the wires or by soldering.

The sensor element may comprise two portions with different cross sections. One cross section is bigger than the other. In an embodiment, the electrical wire is fixed to the side of the portion with the bigger cross section.

The housing may be tightly applied onto a portion of the connecting element. The covered portion may be positioned adjacent to the sensor element. In another embodiment a portion of the connecting element not adjacent to the sensor element is covered.

A tight, impermeable housing is necessary to protect the sensor including the sensor element and the connecting element from chemical impacts of the medium to be measured. Examples where impermeable housings are required are sensors for the temperature measurement of chemicals like automatic transmission fluids (ATFs) or antifreeze chemicals.

At the other end of the wire an electric plug may be provided to connect the sensor element to electric circuitry.

In another embodiment, the connecting element comprises a lead frame.

The housing may be applied onto at least a part of the lead frame. The covered part may be adjacent to the sensor element.

In an embodiment the housing material has a thermal conductivity of 0.2-0.3 W/(m K) at 100° C.

Depending on the application, the thermal conductivity can be adapted by the addition of filler materials. A high thermal conductivity of the housing can be achieved by filler materials having a high thermal conductivity, such as Al₂O₃ and h-BN. This ensures a short response time of the sensor.

In an embodiment the housing material has a coefficient of thermal expansion of 2×10⁻⁴-4×10⁻⁴ K⁻¹.

A low coefficient of thermal expansion ensures a smooth functioning of the sensor in a wide temperature range. The coefficient of thermal expansion can be adapted to the requirements of the application by filler materials.

In an embodiment the housing material has a hardness of 10-90 Shore A.

The hardness may be adapted to the requirements of the application by filler materials. Therefore the housing provides a good protection against environmental mechanical impacts.

In an embodiment the housing material has a dielectric strength of 20 kV/mm or more.

Therefore the housing provides protection against environmental electric impacts and covers the sensor element as an electrically insulating housing.

In an embodiment the housing, which protects the sensor element, has a wall thickness of more than or equal to 0.2 mm. In a preferred embodiment, the housing has a wall thickness between 0.3 mm and 0.2 mm. In a more preferred embodiment, the housing has a wall thickness between 0.21 mm and 0.20 mm.

Due to its advantageous properties like high flowability and low viscosity, LSR can be tightly applied onto the outer surface of the sensor element to form a housing with a low wall thickness tightly enclosing the sensor element. The tight application and low wall thickness of the housing shortens the response time of the sensor.

In an embodiment the connecting element is covered by the housing.

In this embodiment the housing is applied onto both the sensor element and connecting element. There is no gap in the housing between the sensor element and the connecting element. Such a tight, impermeable sealing is at least required if the sensor is used for measuring the temperature of a chemically aggressive medium. The housing should be at least impermeable to liquids and chemically aggressive vapours and gases.

In an embodiment the housing is applied by injection molding.

When applied by injection molding, the housing can be applied onto the sensor element in one step. The inner surface of the housing material smoothly adapts to the shape of the sensor element during injection. The outer shape of the housing is formed by a mold.

In an embodiment the housing is applied by liquid injection molding.

In a liquid injection molding process for LSR, two viscous liquid educt components A and B containing polymers of different chain lengths are provided.

The component B may comprise a first educt polymer and a cross-linker. Herein the cross-linker stimulates a cross-linking reaction between the provided educts. By cross-linking the educt polymers form a three-dimensional grid.

The component A may comprise a second educt polymer and a catalyst. The catalyst may comprise a noble metal. For example, the catalyst is a platinum catalyst.

The first and the second educt polymers may comprise the same type of molecule or different types of molecules. The educt polymers comprise polysiloxanes.

In an embodiment, the components A and B may comprise the same type of polysiloxane with organic substituents. The organic substituents may comprise one or more of the group of methyl, vinyl, phenyl or similar organic substituents.

Herein, the cross-linker is required to stimulate a cross-linking reaction between the provided educt polymers in order to convert the raw rubber into a cured silicone rubber. By cross-linking the polymers form a three-dimensional grid.

The catalyst accelerates the cross-linking reaction. Noble metal catalysts and in particular platinum catalysts show high performance in accelerating the cross-linking reaction.

Before the injection, the both components are mixed to a reaction mixture and cooled to retard the cross-linking reaction.

For curing the mixed components, the cross-linking reaction is triggered by heating during or after injection. Alternatively, the cross-linking reaction is started by exposure to UV-radiation. Which alternative is selected depends on the properties of the used educt materials. After curing the housing material is infusible.

The described liquid injection molding process is preferred since liquid educts are used. For the injection of liquid educts a comparatively low injection pressure is required. Therefore more sensitive sensor elements with more sensitive structures at their outer surface can be covered by this method without the risk of damaging the sensor during injection molding.

In a preferred embodiment, educt components with low viscosity are chosen. The lower the viscosity, the lower the required pressure for injection.

The viscosity of the reaction mixture is between 50,000 and 500,000 [mPa s], depending on the type of used LSR. The reaction mixture may have thixotropic properties. Therefore the viscosity may decrease during the injection molding process.

### BRIEF DESCRIPTION OF THE DRAWINGS

In the following, further exemplary embodiments of the invention are described in detail by reference to figures. However, the invention is not limited to these embodiments. In the figures, similar elements, elements of the same kind and identically acting elements may be provided with the same reference signs.

FIG. 1 shows a first embodiment of the sensor with a cuboid housing and a connecting element;

FIG. 2 shows a sectional view of the first embodiment wherein leads of the sensor element are soldered to wires of the connecting element;

FIG. 3 shows the first embodiment in another perspective view;

FIG. 4 shows a second embodiment of the sensor with a two-part cylindrical housing and a connecting element; and

FIG. 5 shows a sectional view of the second embodiment wherein leads of the sensor element are crimped with wires of the connecting element.

### DETAILED DESCRIPTION OF ILLUSTRATIVE EMBODIMENTS

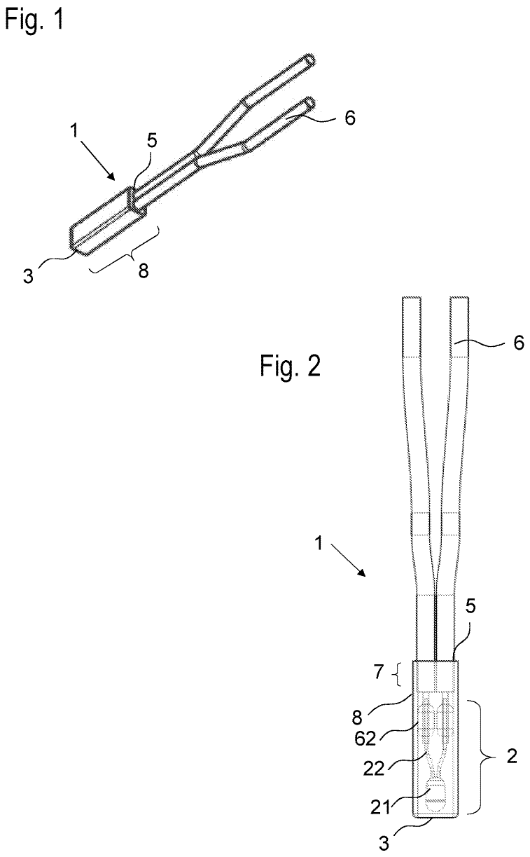

The sensor 1 in FIGS. 1 to 3 comprises a sensor element 2 comprising a temperature-sensitive member 21 and a pair of leads 22. The pair of leads 22 for electrical connection is arranged between the temperature-sensitive member 21 and a connecting element.

The whole sensor element 2 is covered by a one-part and tight and impermeable housing 8, fully encapsulating the sensor element 2. In the present embodiment the housing 8 has a cuboid shape. The shape and structure of the housing 8 can be modified according to the application of the sensor.

The temperature-sensitive member 21 is arranged at a first end of the sensor element 2 designated as sensor head 3 inside the housing 8.

The temperature-sensitive member 21 consists of a thermistor material. In the first embodiment the thermistor material has a negative thermal coefficient. In another embodiment the thermistor material may have a positive thermal coefficient.

The leads 22 consist of an electrically conductible material such as nickel, copper, silver, a similar conductive metal or one of their alloys. The leads 22 are fixed to the temperature-sensitive member 21 at a side opposite to the sensor head 3. The leads 22 are directed away from the sensor head 3.

The sensor element of the first embodiment has a cylindrical shape and a diameter of ≤2.4 mm.

The sensor 1 of the first embodiment is used for temperature measurements. Possible applications are, for example, temperature measurements of chemical fluids or solid surfaces. The sensor 1 is designed for temperature measurements in an extended measuring range from −40° C. up to 250° C.

Therefore the sensor head 3 on the first end of the sensor housing 8 is in contact with a surface to be measured.

The heat of the medium 4 is quickly conducted to the temperature-sensitive member through the thin housing 8 at the sensor head 3.

At a second end 5 of the sensor housing 8 two insulated wires 6 are fixed to the leads of the sensor element 2 as an electric connecting element. The wires 6 are fixed to the leads by solder 62. The part of the wires 6 which is in contact with the leads 22 is not insulated. The insulation of the remaining wires consists of a silicone material.

In the present embodiment the second end 5 is the side of the housing 8 with the largest distance to the sensor head 3.

Only a part of the insulated wires 6 is shown in the figure. Further portions of the insulated wires 6 are not shown in the figure. At the end of the insulated wires 6 not shown in the figures a plug may be fixed to connect the insulated wires 6 with electric circuitry.

In the shown embodiment a portion 7 of the insulated wires 6, adjacent to the sensor element 2, the solder connection 62 and the sensor element 2 are covered by the housing 8.

The housing 8 comprises liquid silicone rubber (LSR) as the main component. The housing is applied onto the sensor by injection molding. The molded housing 8 consists of only one layer whose inner surface adapts smoothly and tightly to the shape of the sensor element 2. Therefore the housing 8 fits closely with the sensor element 2. The outer surface of the housing is formed by a mold.

The housing material may comprise further components. LSR being the main component, the ratio of LSR in the housing material is at least 50 wt %. Additionally, the housing material comprises additives and filler materials. Possible filler materials are oxide ceramics, which contain oxides of silicon and/or aluminium. Further, nitrides such as AlN and BN or carbides such as SiC may be used as filler materials.

Such filler materials can influence several properties of the housing material like its tensile strength, hardness, dielectric strength, thermal elongation and thermal conductivity.

Besides, coloring agents can be added to colorize the transparent LSR material.

However, the housing material consists of one single homogeneous layer, wherein the added agents are homogenously dispersed in the LSR phase.

The housing material of the first embodiment is applied onto the sensor 1 by liquid injection molding. Due to the low viscosity of the liquid educts, a low housing wall thickness at the sensor head 3 ≥0.2 mm can be achieved. The low housing wall thickness shortens the response time of the sensor.

Furthermore, the housing material has strong hydrophobic properties and thus provides good protection for the electric components against water and humidity.

The possible elongation before breaking of the chosen housing material is more than 100%. The elongation is defined as the possible elastic deformation of a component relative to its original length. Due to its tightness and elasticity, the housing provides strong mechanical protection, especially in shock absorption.

Furthermore LSR shows a high chemical resistance. Therefore it is suitable to protect the sensor during temperature measurements in aggressive chemical mediums.

The viscosity of the uncured LSR depends on the respective application and ranges between 50,000 and 500,000 [mPa s]. The viscosity decreases during the molding process due to the shear thinning behaviour of the LSR material.

The uncured LSR is a mixture of liquid components comprising a component A and a component B. The component A comprises polysiloxane with organic substituents and a platinum catalyst. The component B comprises also polysiloxane with organic substituents and a cross-linker.

The components A and B may comprise the same type of polysiloxane with the same organic groups or different types of polysiloxane with different organic groups. The organic substituents may be methyl, vinyl, phenyl or similar substituents.

By exposure to UV-radiation or heating, a cross-linking reaction of the polysiloxane is triggered. The cross-linking reaction converts the liquid mixture to a solid housing material.

The cured LSR has the following properties: The thermal conductivity of LSR without an additive at 100° C. is typically between 0.2 and 0.5 W/(m K). The coefficient of thermal expansion is approximately 2×10⁻⁴-4×10⁻⁴ K. The compression set typically amounts to 5 to 25%. The hardness typically amounts to 10 to 90 Shore A. The dielectric strength according to DIN IEC 243-2 is 20 kV/mm or more.

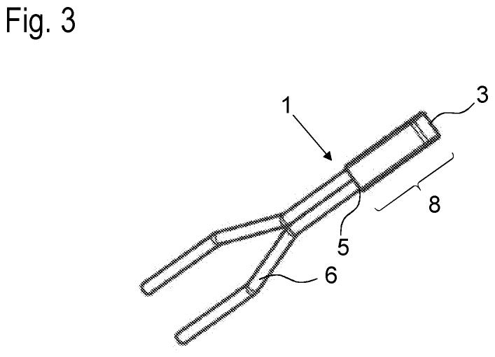

FIG. 3 shows the first embodiment of the sensor 1 from a different perspective. The elements that have been described above are not be described again.

In the first embodiment the insulated wires 6 each consist of a single wire. In another embodiment the wires 6 are stranded wires.

In a further embodiment the sensor element may be contacted by more than two insulated wires.

In yet a further embodiment the sensor comprises two or more sensor elements covered by the same or several housings.

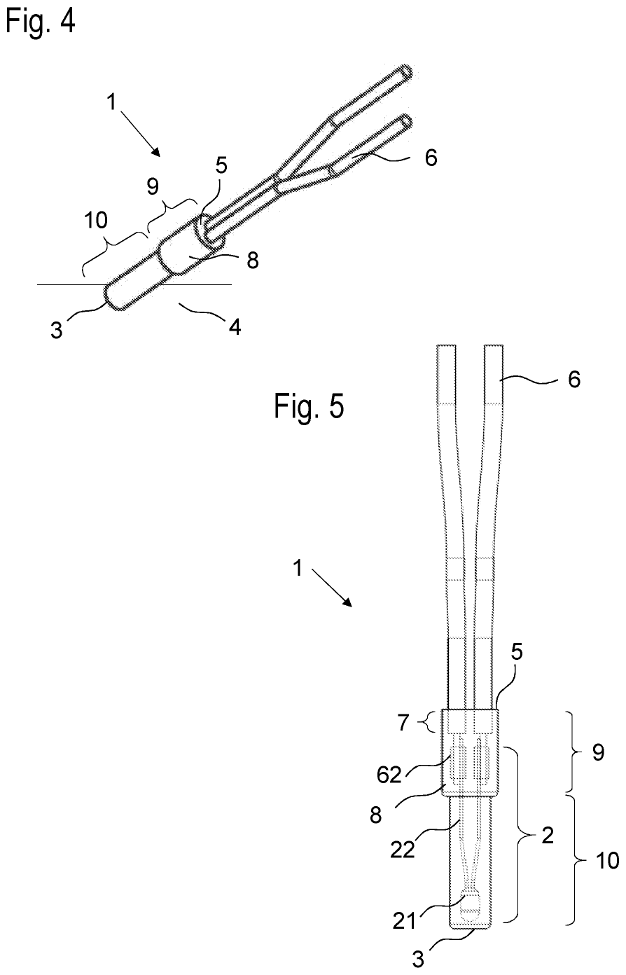

FIGS. 4 and 5 show a second embodiment of the sensor 1. Basically, the second embodiment is similar to the first embodiment of the sensor 1.

Different to the first embodiment, here the sensor housing 8 is shaped as a two-part cylinder. The part 9 of the cylinder at the second end's side 5 has a higher diameter than the part 10 at the first end's side 3.

Therefore, the part 9 at the second end's side 5 can accommodate a crimped connection 62 between the wires 6 and the leads 22. A portion of the wires 6 which is in contact with the leads is not insulated. The leads are arranged at the second end's side 5 of the temperature-sensitive member 21 and are directed away from the sensor's head 3.

The sensor element 2, the crimped connection 62 and a portion 7 of the wires 6 are covered by the housing 8.

A fluid medium 4 to be measured is at least in contact with the thinner part 10 of the sensor housing 8 comprising the sensor head 3. The thin wall thickness at the thinner part 10 of the housing 8 allows a short response time for temperature measurements. In another embodiment, the whole housing 8 and the insulated wires 6 are in contact with the medium to be measured 4.

In a forth embodiment, not shown in the figures, the connecting element for electrical connection is a lead frame instead of wires.

Although the invention has been illustrated and described in detail by means of the preferred embodiment examples, the present invention is not restricted by the disclosed examples and other variations may be derived by the skilled person without exceeding the scope of protection of the invention.

1.-12. (canceled)

13. A sensor comprising:
a sensor element;
a connecting element configured for electrical connection; and
a housing located on the sensor element,
wherein the housing comprises a housing material with cured liquid silicone rubber (LSR) as a main component.

14. The sensor of claim 13, wherein the sensor element comprises a temperature-sensitive member.

15. The sensor of claim 14, wherein the temperature-sensitive member comprises a thermistor material.

16. The sensor of claim 13, wherein the connecting element comprises an electrical wire.

17. The sensor of claim 13, wherein the connecting element comprises a lead frame.

18. The sensor of claim 13, wherein the housing material has a thermal conductivity of 0.2-0.3 W/(m K) at 100° C.

19. The sensor of claim 13, wherein the housing material has a coefficient of thermal expansion of 2×10⁻⁴-4×10⁻⁴ K.

20. The sensor of claim 13, wherein the housing material has a hardness of 10-90 Shore A.

21. The sensor of claim 13, wherein the housing material has a dielectric strength of 20 kV/mm or more.

22. The sensor of claim 13, wherein the housing is arranged on a part of the connecting element.

23. The sensor of claim 13, wherein the housing is applied by injection molding.

24. The sensor of claim 23, wherein the housing is applied by liquid injection molding.
